(19) United States
(12) Patent Application Publication
(10) Pub. No.: US 2018/0025420 A9
(43) Pub. Date: Jan. 25, 2018

(54) Electronic Document Management with Requesting and Exchange Protocol Based On User Defined Rules, User Selected Status; Status Indications Automatically Generated Based on User and/or Aggregated Data, and/or Rules Based on User Data and/or Aggregated Data

(71) Applicant: Scott Gerard Wolfe, JR., New Orleans, LA (US)

(72) Inventor: Scott Gerard Wolfe, JR., New Orleans, LA (US)

(21) Appl. No.: 15/130,555

(22) Filed: Apr. 15, 2016

Related U.S. Application Data
(60) Provisional application No. 62/148,884, filed on Apr. 17, 2015.

(51) Int. Cl. G06Q 40/02; G06Q 10/10

(52) U.S. Cl. CPC G06Q 40/02; G06Q 10/10

(57) ABSTRACT

This invention, through a computer or computer program (software code understood by a computer and displayed to a user through an interface), creates a systemized process and method of requesting, approving, exchanging, and managing documents—either in electronic or paper format—between multiple participants to a construction endeavor or related endeavor. The system, method, and process specifically enables the user(s) to request, approve, exchange, and manage said documents according to certain protocols and processes that are defined, guided, and controlled by user defined rules, user selected status, status indications automatically generated based on user data, status indications automatically generated based on aggregated data, rules based on user data, and/or rules based on aggregated data.

### CROSS REFERENCE TO RELATED APPLICATIONS

This Nonprovisional Utility patent application claims the benefit of a previously filed provisional patent under 35 USC 199(e), the application number of the previously filed provisional patent application is 62/148,884.

### STATEMENT REGARDING FEDERALLY SPONSORED RESEARCH OF DEVELOPMENT

Not Applicable

### REFERENCE OF SEQUENCE LISTING, A TABLE, OR A COMPUTER PROGRAM LISTING COMPACT DISC APPENDIX

Not Applicable

### BACKGROUND OF THE INVENTION/SUMMARY OF THE ART

The construction industry is a complicated industry in which many different scenarios, arrangements, and relationships can exist between participants involved with particular projects. These scenarios, arrangements, and relationships relate to the performance of work, the furnishing of materials, payment arrangements, or other intricacies of construction projects. Projects can be residential, commercial, state, federal, or some combination of these, and projects vary drastically in size and sophistication. Depending on the exact nature and scope of a construction project, the number of participants involved can range from a single participant to a large number of participants. Likewise, the relationships between the various participants in a construction project can range from simple to extraordinarily complex.

Every construction project is initiated by some party (the “Initiator”). The party in this role can be a property owner, commercial developer, property management organization, building or facility tenant, state government, local government, federal government, government organization, joint venture, or private/public organization—however, this is an illustrative, not exhaustive, list. The “Initiator” is the project participant who is seeking the construction project itself, to benefit from the project's conclusion and delivery.

Though an “Initiator” is nearly always present, the other participants that may be involved on the project can vary significantly. For the purposes of this document we will refer to participants as being “Above” or “Below” the initiator on the project, which refers to whether the participant is receiving money below the initiator (i.e. the Initiator is paying money down to that party, whether directly or through intermediary parties), or is providing money above the Initiator (i.e. the initiator is receiving money or some financial or risk management benefit from that party).

Participants that are Above the Initiator may include, among other parties not listed here, construction lenders and banks, financing organizations, and sureties. Participants that are Below the Initiator may include architects, engineers, construction managers, general contractors, subcontractors, sub-subcontractors, sub-sub-subcontractors, material suppliers, equipment providers, equipment rental companies, and more. Again, this list is not exhaustive.

It is a significant challenge in the construction industry to ensure that projects are performed as planned and that a product (i.e. a particular project) is delivered to the Initiator as requested—on time, unburdened with liens or other claims, and with all parties paid. Accordingly, it is also a large and pervasive challenge in the construction industry to make sure that every project participant is compensated fully and timely for the materials, equipment, services, and/or labor furnished to the endeavor.

American laws exist to protect project participants from non-payment or slow-payment. Examples of these laws include prompt payment requirements, criminalization of funds misappropriation, payment bond requirements, and mechanics lien rights.

The present invention relates to the field of financial risk shifting and financial risk management, through the use of documents that are requested, exchanged, tracked, and/or managed. And, while directly applicable in and to the construction industry, the invention is not limited to such use, and can be of value in any industry or situation in which the requesting, approving, exchanging, tracking, and management of certain documents that are used to manage, shift, control, and understand financial risk within an organization, and specifically within the context of certain contractual relationships is necessary or contemplated. This structure and need is specifically present and contemplated by the structure of construction projects.

This invention, through a computer or computer program (software code understood by a computer and displayed to a user through an interface), creates a systemized process and method of selecting, organizing, requesting, approving, and exchanging certain documents, as well as the process of tracking, managing, and organizing the same; and applies said process through user defined rules, user indicated statuses, and status indications and changes that are automatically generated based on user or aggregated data or rules based on user data and/or aggregated data.

Construction industry participants have a special and particular interest in mechanics lien rights—both their own rights and the rights of other project participants. For the purposes herein, the term “Mechanics Lien” and “Lien” will refer to all types of security devices and remedies available in the construction industry, including, but not limited to, mechanics liens, construction liens, materialman liens, contractor liens, architect or design professional liens, laborer liens, bond claims, payment bond claims, stop notice claims, miller act claims, and little miller act claims. Further, the scope of this discussion shall also refer to and extend to other analogous complex situations in which participation is required to conduct some endeavor, and where some security or other right is bestowed upon participants (whether automatically or through action taken to obtain said right), such as is the case with oil & gas projects or other similar works, and such right can be managed or waived by the exchange of certain documents.

For those “Below” the Initiator, the Lien right is available to protect them in the event of non-payment or slow-payment by providing a security interest. Accordingly, it is in the “Below” parties legal and practical interest to keep that right intact and available to it at all times that it is performing on the project until the party has actually received full and complete payment.

However, since the Lien right ultimately gives those “Below” the Initiator an interest in the property or project that is being worked upon, the Initiator and those “Above” the Initiator, who are all interested in preserving their own undisrupted position in the property and/or project, have legal and practical interests in avoiding Liens and escaping the “Below”-parties' Lien rights to mitigate the risk that the rights may be used on the project.

The practice of preserving the right by “Below” parties and avoiding the right by “Above” parties is complicated. Project participants leverage a number of different philosophies, procedures, and/or tools to perform this task.

This document will discuss one specific procedure, document, and tool that the Initiator, Above, and Below parties leverage to perform the task of either preserving the lien right or mitigating the possibility of the lien right being used: the lien waiver.

While specifically related and applicable to the Lien waiver process, this invention refers and relates to a wider range of procedures and tools related to the exchange of a document (the timing, content, and exchange of which is based upon certain criteria), and not simply the lien waivers. Accordingly, the reference to lien waivers is illustrative only, and not an exhaustive list of potential tools, procedures, or documents to which this invention is applicable, and is not an exhaustive list of how this particular invention can be used by appropriate users.

### Lien Waivers:

The lien waiver document is a legal document with a long history of use in United States law. Most simply, this document contains language indicating that a lien right has been “waived,” and is delivered by a Below party to a party above her (including, but not limited to the Initiator or any other party who hired the Below party). These documents may require some generic legal language or other language referencing the waiver of the lien right, or may have specific formal requirements set forth by state stature. The document is delivered by the Below party to the Above party(ies), generally in exchange for a payment, or a promise of payment.

In some respects, therefore, the lien waiver document can be very similar to a receipt or proof of payment that has the added function of dismissing rights to the payment evidenced. One party makes a payment (the payor)—or promises to make a payment, and in exchange, the other party (the payee) delivers the lien waiver document waiving her lien rights for that particular payment.

The exchange of this document is designed to satisfy the Initiator, the Above parties, and the Below parties. For the Above parties and the Initiator, the lien waiver document assures them that a lien right may not and will not be used against the project for the work/payment contemplated by each particular waiver received, thus keeping the property and project free of encumbrances that could otherwise cause problems. For the below party, the lien waiver document is consideration to prompt, and is being exchanged for, payment, and accordingly, the lien right will not be needed because the payment is in hand.

However, there is a phantom catch-22 for the participants with respect to these lien waiver documents. Below participants are oftentimes apprehensive about delivering the lien waiver document to the Initiator or Above parties until the payment has actually been delivered, and conversely, Initiators and Above participants are apprehensive about delivering payment to the Below party before the lien waiver document has been obtained. The apprehension is based on the fear that either the Below party, or those below even them, will use lien rights in spite of the payment, or the Initiator or Above party will not pay after the lien waiver is furnished.

This, however, is not an actual problem, it is only perceived as such. It is not an actual problem because (1) There are legal avenues to deliver “conditional” lien waiver documents that can be signed by a Below party before payment is received but is only legally enforceable by the Initiator or Above party after payment is received; and (2) Laws exist that can protect Below parties against an Initiator or Above party attempting to enforce a lien waiver that is based on a payment not actually made.

The above-discussed perceived catch-22 is the subject of a few patent applications inventing a “construction payment management” system (including U.S. Pat. Nos. 7,672,888; 7,725,384; 7,877,302; 8,180,707; 8,244,606; and 8,296,199). The functionality of these patent-protected systems enable the Below parties to submit payment requests to the Initiator or Above parties, and then, along with said requests also submit an electronically signed lien waiver document. The system and method protected by the above-referenced patents purports to pass the payment request onto the Initiator or Above party, but to hold the electronically signed lien waiver in escrow until the payment is actually received. When the payment is received by the Below party, the lien waiver is released out of escrow and delivered to the Initiator or Above party. The same escrow method can be accomplished by holding both the payment and the lien waiver in escrow and then simultaneously exchanging them by delivering to the appropriate party.

The “construction payment management” system patented through the above-referenced patents solves the perceived catch-22 problem that does not actually exist.

The invention made the subject of this application does not create a payment management system, and is distinguishable from the construction payment management system patent grants above-referenced because, among other reasons, the electronic requesting and exchanging of lien waivers (and other legal documents) is not related to, connected with, dependent upon, or associated in any way with any holding, escrowing, or entrusting of the underlying document to the system.

The rules surrounding lien waiver documents are different from state-to-state and project-to-project. This includes the rules related to which lien waiver forms may or must be used by the participants. Generally, however, lien waiver documents fall into one of the four following categories:
Conditional Partial Waivers
Conditional Final Waivers
Unconditional Partial Waivers
Unconditional Final Waivers

Conditional waivers are effective, by law and/or pursuant to the terms of the lien waiver document itself, only after the “condition” on which the waiver is based has been satisfied. This condition is almost exclusively the receipt of the actual related payment.

This type of document enables Below participants to sign and deliver the waiver before receipt of payment without any apprehensions since it is effective only upon receipt of payment, and likewise, the Initiator or Above parties are assured that the lien waiver is effective immediately upon their payment to the Below party.

Unconditional waivers are effective, by law and/or pursuant to the terms of the lien waiver document itself, immediately upon execution and delivery. This type of waiver is unconditional upon any receipt of payment, and contemplates that payment has already been exchanged.

Finally, both the conditional and unconditional waiver types can be either “partial” or “final.” Partial, or “progress” lien waivers regard payment exchanges, billing requests, and are waivers of lien rights that for only some portion of the whole of the contract. For example, if a party had a $100 contract and was being paid only $20, the payment and waiver would only be partial to the whole. As parties in the construction industry are often paid incrementally throughout the course of the project, these waivers can be exchanged throughout the project to the benefit of all parties, without waiting for full and final payment at the end of the project as a whole.

Final lien waivers, on the other hand, signify the completion of all payments, billings, and/or waivers of lien rights on the entire contract. Using the above $100 contract example, a final lien waiver would be exchanged when all $100 was being paid, either all at once or through a final partial payment.

In practice, lien waivers are drafted, reviewed, exchanged, and managed in a variety of ways, which can and typically do differ by each participant. The use, interpretation, exchange, and other processing of lien waivers substantially lacks any standards. It is common for participants to settle or agree upon a particular lien waiver form at the beginning of a construction project, and then, upon the request for any payment by a Below party to an Initiator or Above party, the Below party must attach the lien waiver for herself and any parties Below the payment requesting party.

### Lien Waiver and Construction Payment Management Systems:

The current art contemplates the use of an integrated “construction payment management” system to exchange lien waiver (or other electronic) documents between multiple parties through the use of a third-party escrow transaction. (This can be seen through patent Numbers including U.S. Pat. Nos. 7,672,888; 7,725,384; 7,877,302; 8,180,707; 8,244,606; 8,296,199). The functionality of those systems enable the Below parties to submit payment requests to the Initiator and/or Above parties, and then, along with said requests, also submit an electronically signed lien waiver document. That system and method passes a payment request to the Initiator/Above party, but holds an electronically signed lien waiver related to that payment in escrow until the payment is actually received by the third-party escrow system. When the third-party has both the payment and lien-waiver in escrow (or upon the expiration of certain time-limits), the payment is released to the Below party, and the lien waiver is released to the Above party.

This invention described by the instant Specification and contemplated by this application does not create a payment management system, and is clearly and easily distinguishable from the above-referenced construction payment management system patent grants because, among other reasons, the electronic requesting and exchanging of lien waivers (and other legal documents) is not related to, connected with, dependent upon, or associated in any way with any holding, escrowing, or entrusting of the underlying document to the system.

In the current state of the art as determined by the “construction payment management” system patent grants, an electronic document (i.e. the lien waiver) is signed by a payee party at the time of a payment request, and the document is transmitted to the system to hold until payment is made. After payment is made, the system then transmits the escrowed document to the payor party. The newly contemplated system set forth herein does not in practice or effect hold any electronic document in escrow. Instead, this invention contemplates the live exchange of electronic documents based on certain rules, conditions, data, and events. Furthermore, this invention is strictly regarding the exchange and management of electronic documents, and is not a payment management system or a payment request/approval system. Accordingly, unlike the construction payment system patent grants, this particular system and method does not enable or assist the parties in requesting or processing payment.

Aside from these construction payment management systems, there are further arts related to electronic documents, and specifically related to liens waivers.

First, there is the art of document assembly. Document assembly enables a user to assemble a certain document by merging variable data into a fixed form. Accordingly, in the case of lien waivers, the system may contain a database or library of lien waiver forms. These forms will contain certain areas that require dynamic and variable data. The user of the system will input the variable data into a questionnaire, spreadsheet, or input area, and the system will merge that data with the forms in the applicable places, to construct a final document.

Second, there is the art of document tracking (including lien waivers) related to a party's specific status. In this art, the system will allow a user to enumerate or input a list of parties, and thereafter, to associate lien waivers and other document indications with those parties. In these instances, the documents themselves are not necessarily associated with the enumerated party(ies), but instead, there is an indicator associated with the parties.

### Web Applications, Mobile Applications, Widgets, Software, Communications Networks:

The World Wide Web (WWW) is a network of computers, through which users around the world can access information displayed within a web browser. Typically the user accesses certain web pages that are displayed to the user through the HTML (Hyper-Text Markup Language) protocol. The user calls and retrieves specific HTML pages by requesting the page through a known URL (Uniform Resource Locator) using HTTP (HyperText Transfer Protocol).

Using certain computer languages such as PHP, Javascript, and HTML, listed here illustratively only and as examples, it has become common for companies and individuals to write applications that run and operate through web browsers on the World Wide Web. These web applications are similar to software applications that are written to operate on a user's desktop, except that they run through web browsers on the web.

Typically, a user will visit a certain website and be required to login to their account. Once logged in, the user will have access to the web application and its features. A web application can be designed to appear on a web browser access via a personal computer, or on a “mobile browser,” which is a web browser optimized for viewing on a mobile device.

Although web applications viewing on a standard web browser may be viewed on a mobile device through a mobile web browser, mobile devices also have the ability to run native mobile applications. These applications are optimized to operate on a mobile device (such as an iPhone or iPad, or an Android OS device) with or without the use of an Internet connection. The user opens the application on his or her mobile device and is able to view, alter, and interact with the application without the use of a browser.

A “widget” is a term of art defined by Wikipedia as “a small application that can be installed and executed within a web page by an end user,” and more further described therein as “a stand-alone application that can be embedded into third party sites by any user on a page where they have rights of authorship.” Other terms used to describe web widgets include: portlet, gadget, badge, module, webjit, capsule, snippet, mini, and flake.

A widget may be installed on any web page, displaying content to the viewer, or offering a certain application or function to the viewer. When an application or function is offered, the widget runs a script stored on the originating server, such that the viewer is able to complete a function within the widget without the host-site storing the function's code and framework.

A “software platform” is a computer system much like a web application, as above described, but installed locally on a server or computer device, as opposed to be hosted on the web.

For the purposes of this Specification, all of these applications, interfaces and networks, together with other non-discussed offline software systems and electronic communications, are collectively referred to as the “System” or “Application.”

### BRIEF SUMMARY OF THE INVENTION

This invention, through a computer, computer program, system, or application, is a system, method, and process of requesting, approving, exchanging, and managing documents—either in electronic or paper format—between multiple participants to a construction endeavor or related endeavor. The system, method, and process specifically enables the user(s) to request, approve, exchange, and manage said documents according to certain protocols and processes that are defined, guided, and controlled by user defined rules, user selected status, status indications automatically generated based on user data, status indications automatically generated based on aggregated data, rules based on user data, and/or rules based on aggregated data.

An example discussed in this document of how this invention may be applied relates to lien waiver documents, but the invention is not specifically limited to lien waiver documents and, instead may be applied to other document exchanges, as well.

### Regarding Lien Waivers:

This invention enables a user to request a lien waiver from another party or from multiple parties, for those parties to receive the request, and then to electronically sign and provide a lien waiver document in response to the request through the system. The responsive lien waiver document itself would be determined dynamically by the system. Furthermore, upon the happening of certain events or the change in certain data or circumstances, the system could dynamically send lien waiver documents or additional lien waiver documents to the requesting party.

For example, a lien waiver may be requested by Above party from a Below party. The system would examine the payment status to determine whether payment has been received, not received, or whether payment status is unknown. This could be a payment indication provided manually by the user, or a review of data within the system that is delivered by the data provided by the requesting or the responding user or party. The system could also examine other data points, such as: (i) The preferences manually set by the receiving or requesting party about the other respective parties; and/or (ii) The preferences set by the receiving or requesting party about specific risk tolerances it has related to the document at issue (for this example lien waivers). Based on the system's examinations of one or multiple data points, as the case may be, the system will select the lien waiver document type to deliver, or, alternatively, the lien waiver document could be manually selected by the user. If the system or user determines that payment had not yet been made, it may determine to select, prepare, electronically sign, and deliver a “Conditional” lien waiver document. Thereafter, the status or data may change within the system, either manually or automatically, which may result in the system performing an additional action, such as the preparation, electronically signing, and delivering of an “Unconditional” lien waiver document.

Further, based on a user's preferences, the user could establish a self-service center whereby any relevant party could view pertinent information and generate lien waiver documents on-demand, all based on and driven by the user's preferences, settings, data, and/or manual action.

### BRIEF DESCRIPTION OF THE DRAWINGS

FIG. 1 is a flow chart demonstrating how the invention will process a request for a lien waiver. The request could come from any method, so long as it is received or entered into a system. Any lien waiver request received by the system would have to be identified, or the system would have to be capable of identifying it, with certain characteristics to enable the user preferences to be assigned. Such characteristics may include the type of waiver (i.e. conditional or unconditional) or the stage (i.e. partial or final). After a request, the system would examine the requested waiver against the user's preferences (i.e. the User Preferences Gate) and the user's account and project data (i.e. data about the project or account associated with the lien waiver request). Based on the user's data and the user's preferences, an approval would be determined by the system. If it is approved, the lien waiver document would be generated and delivered to the requester. If it is not approved, the request would be sent to the user's decision queue for manual review and approval or denial.

FIG. 2 is an example of a user's preferences. The user is able to establish, within the system, preferences associated with each type of lien waiver document. The preferences would enable the user to create workflows that automatically approve certain requests, or to approve requests according to certain factors and conditions. Further, a user would be able to preserve the ability to approve or reject requests manually, as per the preferences.

FIG. 3 is a mockup of a sample “Waiver On Demand” page, or a self-service center through which those desiring to receive a lien waiver document could request the documents on demand. As per this mockup, the requesting party would go to a certain area—either online, through a website, through a mobile application, or through some other type of interface—and would select certain information to identify: (i) The project that is associated with the request; (ii) The invoices, work, or materials associated with the request; and (iii) The type of document requested. When the user selects to generate the document, the document would either 1) automatically generate with electronic signature (if approved pursuant to user preferences) or, 2) be sent to the receiving party for approval.

FIG. 4 is a workflow that examines the User Preferences Gate in more detail (from FIG. 1 and FIG. 2). As per this flow chart, the lien waiver is ultimately generated or sent to a queue for approval depending on the preferences established by the user, the lien waiver type and details requested, and the data that the system knows about the user, the user's account, or the associated project, or the associated lien waiver request.

FIG. 5 is a workflow chart that examines the circumstance when a conditional waiver type is generated and sent, through any method, and a follow-up unconditional waiver type may be delivered to the recipient upon the happening of some trigger event within the system, all based on the user's preferences and data.

### DETAILED DESCRIPTION OF THE INVENTION

This invention does not claim the underlying process and/or method of databasing records, generating documents, delivering documents through electronic or non-electronic means, establishing user preferences in general, storing data in general, or accepting in any format the request for certain types of electronic or non electronic information. Further, this invention does not claim the underlying process of examining data against a preference set and making a determination.

Instead, this invention claims and relates to the connecting and associating of following elements, and executing a decision and process regarding the same: (i) The characteristics of a request for a document; (ii) The characteristics of the document; (iii) The user's preferences related to the characterizes of the document; and (iv) The existence of certain elements about the preferences, the documents, the request, and other connected data.

A. System and Method of Enabling Users to Approve Automatically, or Catalog for Manual Approval, Requests for the Generation, Production, and Delivery of Certain Documents, Specifically Inclusive of Lien Waivers, Pursuant to Established User Preferences and/or Dynamic Data about the User

This invention's method performs a process through a computer system to either automatically approve, generate, and distribute lien waiver (and related) documents, or to catalog requests for the same into a decision queue, whereby the user can manually approve, generate, and/or deliver the same.

The structure for this method relies upon some organization in a computer database, program, or other data source, whereby a user has a set of “projects” and/or “account” records. Furthermore, the documents at the center of the invention's function (e.g. lien waiver documents) are also stored within a computer database, program, or other data source, with certain characteristics associated with the documents, such as “conditional,” “unconditional,” “partial,” and “final” designations. Finally, also through the computer database, program, or other data source, the user may also have invoice or payment applications records stored which are all associated with the user, the project records, and/or the account records.

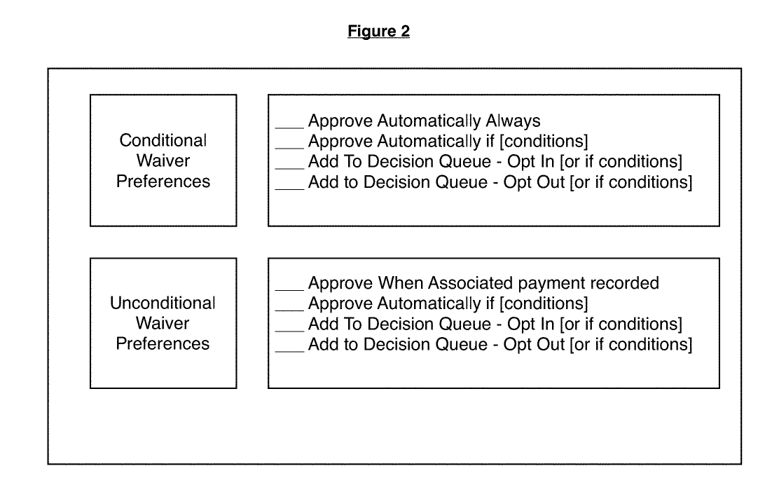

Through this invention, the user can establish certain preferences to dictate how the system will perform the functions of this invention. FIG. 2 demonstrates some example preferences. The user should be capable of establishing preferences that are connected to the different document characteristics and features. And for each characteristic and feature of the document the user should be able to establish workflows for the approval or non-approval of the document in certain conditions.

According to this invention, a requesting party will initiate a request for the delivery or acquisition of some document, which is controlled by the system and cataloged within its database. The requesting party may use any means to make the request to the system.

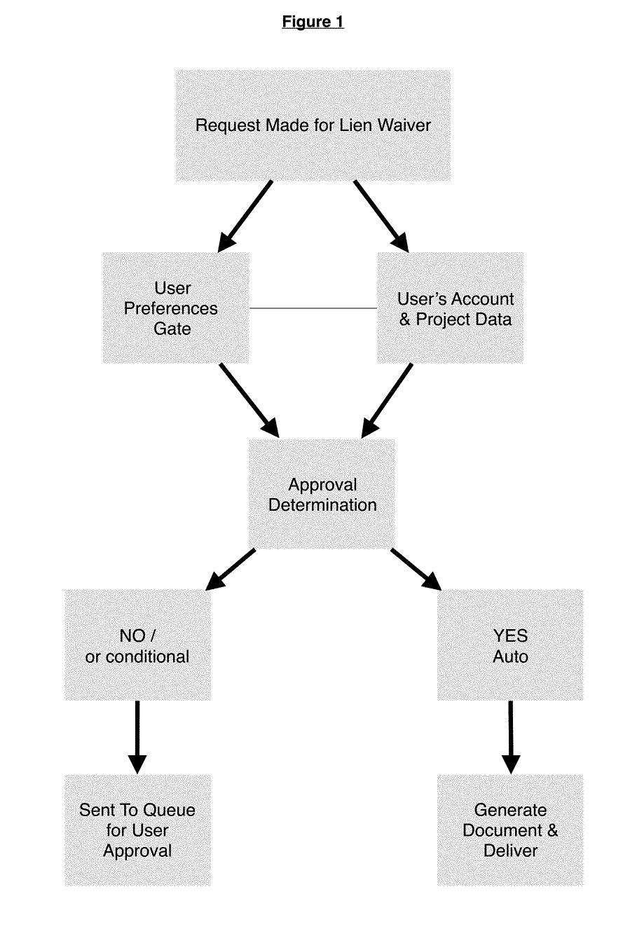

This invention sets forth a system and method, through a computer program or application, for approving automatically, or cataloging for manual approval, the requests for the document. FIG. 1 demonstrates a simple workflow for how the approval or cataloging for manual approval decision would be made by the system subject to this invention such that after the request is received (through any method), the user's preferences gate (e.g. FIG. 2) is examined to contemplate all of the relevant conditions, and then thereafter, the user's account and project data, including invoice and/or payment application data, are examined to determine if the conditions and/or preferences are met. According to whether the qualifications are met, and the specific characteristics of the request, the system and method, through a computer program or application, would either 1) approve, generate, and distribute the requested document or, 2) catalog the request into a decision queue for the user to manually approve, decline, or alter.

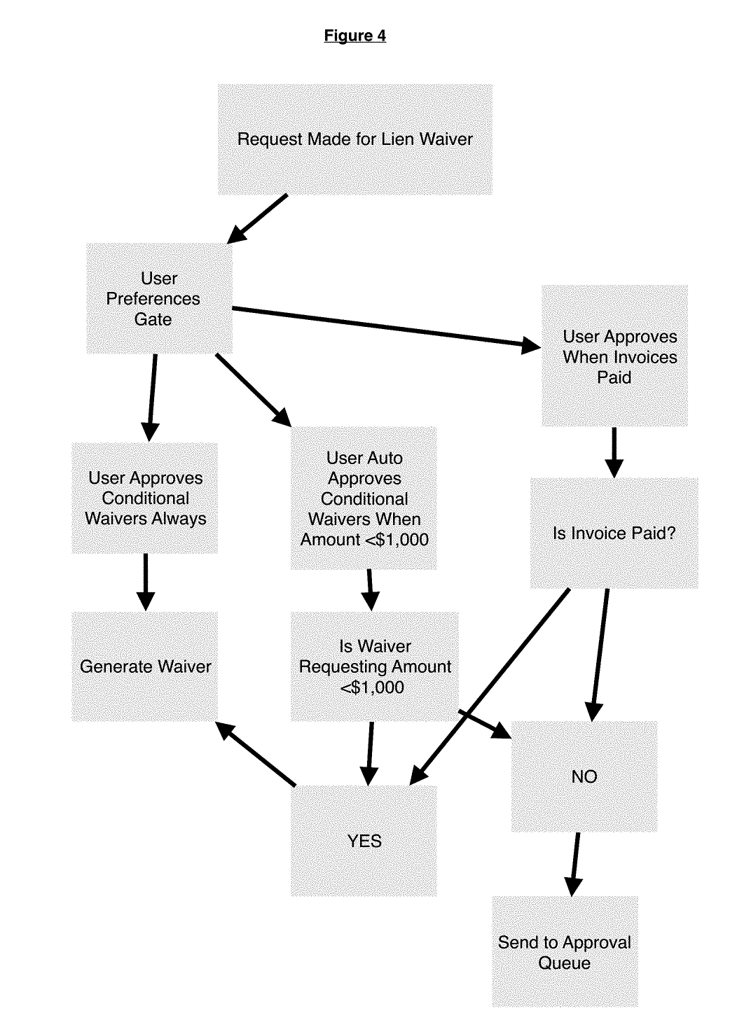

This process and method is further illustrated within FIG. 4. In the FIG. 4 drawing, the “user preference gate” component of FIG. 1 is examined in additional detail. As per this drawing, the computer program or system would examine the request against the user's established preferences. If the preferences dictate an automatic approval, the document would be generated and delivered without any further intervention. If certain conditions are required to be met in order to approve the document, then the document would only be generated and delivered without any further intervention if those conditions are met. Oftentimes, the conditions would be met or not met in connection with the request itself (i.e. if the request is asking for a document implicating less than $1000), but other times the system may need to examine additional data connected to the project or account, such as whether an associated invoice is in a paid or unpaid state.

When conditions are met and an automatic approval is warranted, the document is generated and delivered automatically through the computer system or program. When conditions are not met such that automatic approval is not warranted, the document request will go into a decision queue for the user to approve manually, decline, or modify.

B. System and Method of Enabling a Requesting Party to Request from Another Party Documents Related to a Project, Account, or Job, and to Receive Said Documents “on Demand” and Automatically

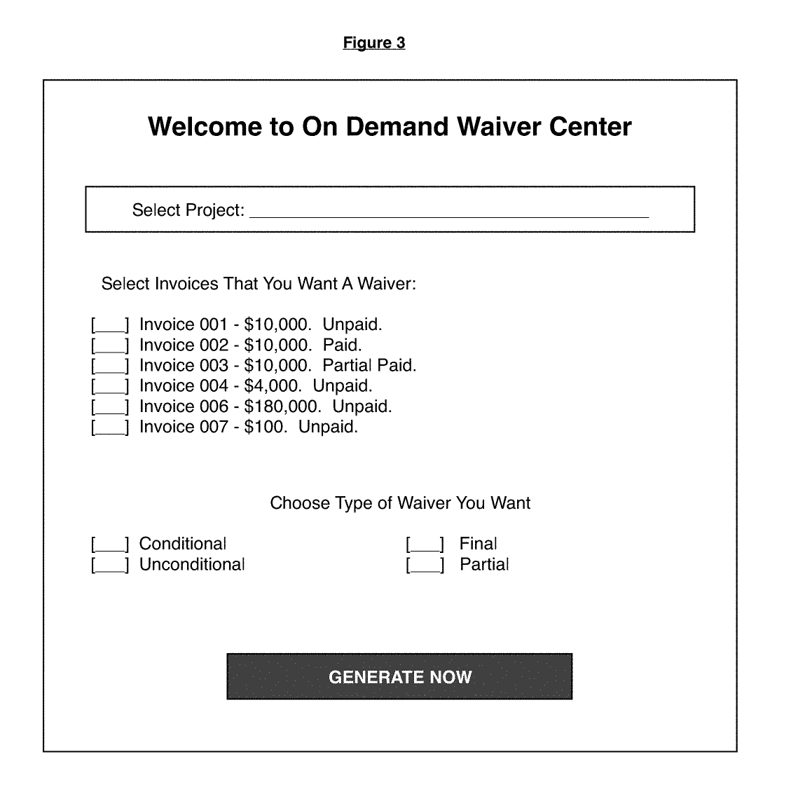

This invention's method and system performs a process through a computer system or program to enable a requesting party to request from another party documents related to a certain project, account, job, or other record. An example use case of this component of the invention is illustrated in the FIG. 3 drawing, which demonstrates an “On Demand Waiver Center.”

As outlined by the drawing FIG. 3, the requesting party, through a computer program, application, or system, would visit an interface where he could search through a database for a certain project, account, job, or user record, as the case may be. Whenever, and however, a project, account, job, or user record is located, the system would display to the user information related to that specific record. In the FIG. 3 example, the system displays the invoices associated with the selected project record. The requesting party is capable of selecting the invoice items that are applicable to her request, and then identifying the type of document (i.e. here, a “waiver”) she wants to receive, which is asking the requester to select the document characteristics. Upon selecting this information, the requesting party can then tell the system to proceed with generating the requested document, whereupon the system will employ the method of this invention to compare the request with the user's preferences and stored data, and determine whether the document can be automatically generated and approved, and 1) do so, if possible, or 2) if not, place the document request in a queue for manual approval by the user.

### C. System and Method of Automating the Generation and Delivery of Certain Documents Upon the Happening of Certain Trigger Events

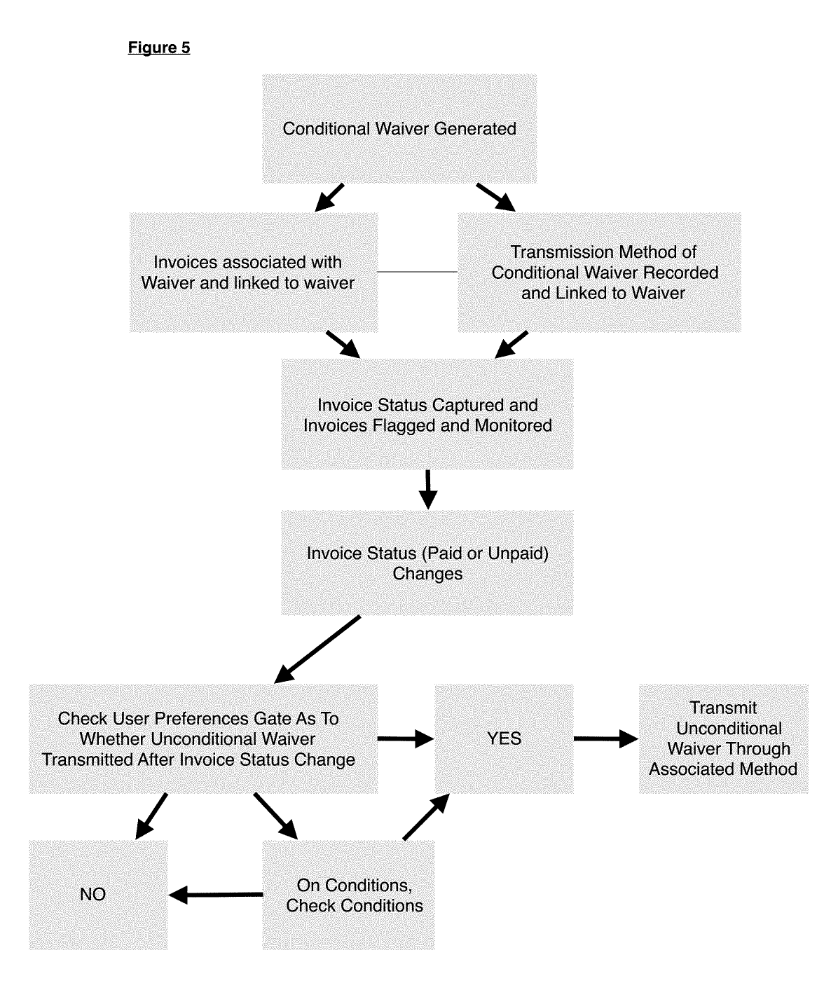

This portion of the invention is a method and system, performed through a computer program or system, of automatically approving, generating, and delivering designated documents upon the happening of certain triggers that are established by the user. A use case demonstrated in this application is illustrated in FIG. 5.

In this FIG. 5, when a conditional lien waiver document is created by the system, or otherwise associated within the system to any project, account, or job record, the system, through the computer or computer program will record and associate certain information about the conditional waiver. This information includes: (i) Which invoices are associated with the waiver; (ii) The status of those invoices; and (iii) The method by which the conditional lien waiver was transmitted to any third party or requesting party.

The system will then, through the computer or computer program, monitor the status of those identified and associated invoices. When the invoices' status changes from an “unpaid” status to a “paid” status, the system, through the computer program or computer, will examine the user's preferences about whether an unconditional lien waiver document should be automatically transmitted. In the event the conditions as set forth by the user's preferences are met such that the invoice(s) are eligible for an unconditional waiver, the system will transmit the same to the party associated with the original waiver.

### DRAWINGS

Drawings (FIGS. 1-5) are attached hereto.

1-10. (canceled)

11. A method for processing a request for a lien waiver document comprising:
an electronically communicative lien waiver document processing computer comprising program code and storage, the program code stored in the storage and adapted to process a lien waiver document comprising the steps of:
receiving, at the lien waiver document processing computer, request data for a lien waiver associated to the request from a requester;
identifying, at the request data, a provider;
identifying, at the request data, a lien waiver document type;
identifying, at the request data, a lien waiver document stage;
identifying, at the request data, a plurality of user preferences;
determining an approval status by examining the request data based on the plurality of user preferences;
upon the approval status being approved:
generating the lien waiver document for delivery;
delivering the lien waiver document to the requester;
upon the approval status being not-approved, sending the request data to a decision queue.

12. The method of claim 11, wherein the lien waiver document type is a conditional waiver document or an unconditional waiver document;

13. The method of claim 12, wherein the lien waiver document stage is partial or final;

14. The method of claim 13, wherein;
upon the document type being a conditional waiver document, the plurality of user preferences is selected form the group consisting of, approve automatically always, approve automatically if a first condition is met, add to the decision queue opt-in if a second condition is met, and add to the decision queue opt-out if a third condition is met;
upon the document type being an unconditional waiver document, the plurality of user preferences is selected form the group consisting of, approve when associated payment recorded, approve automatically if a fourth condition is met, add to the decision queue opt-in if a fifth condition is met, add to the decision queue opt-out if a sixth condition is met.

15. The method of claim 14, wherein the programming code is further configured to provide a workflow to automatically approve the request based on the plurality of user preferences.

16. The method of claim 11, further comprising the steps of:
identifying, at the request data, financial data;
alternatively determining an approval status by examining a payment status based the financial data;
upon the payment status being paid, setting the approval status to approved;
upon the payment status being unpaid, setting the approval status to not-approved.

17. The method of claim 11, wherein prior to delivering the lien waiver document to the requester, electronically signing the lien waiver document.

18. The method of claim 11, further comprising the steps of:
identifying, at the request data, a plurality of status indicators.

19. The method of claim 18, wherein the status indicators comprise at least, a status of work performance, and whether or not at least a portion of work has been completed.

20. The method of claim 11, further comprising the step of:
automatically generating, based on aggregated data, rules based on the plurality of user preferences.

21. A method for processing a conditional lien waiver document comprising:
an electronically communicative lien waiver document processing computer comprising program code and storage, the program code stored in the storage and adapted to processing a conditional lien waiver document comprising the steps of:
associating, at the conditional lien waiver document, one or more invoices;
associating, at the conditional lien waiver document, one or more statuses, each status associated to the one or more invoices;
associating, at the conditional lien waiver document, a method of transmittal;
continuously monitoring, by the program code, the one or more statuses;
upon detecting, by the program code, a status change in the one or more statuses:
examining, by the program code, a plurality of user preferences to determine whether or not the conditional lien waiver document should be transmitted;
checking, at a first user preference, if an unconditional waiver is eligible;
upon eligibility of an unconditional waiver, transmitting, by the method of transmittal, the unconditional lien waiver document to a user computer associated to a party associated to the conditional lien waiver document
upon ineligibility of an unconditional waiver, transmitting, by the method of transmittal, the conditional lien waiver document to a user computer associated to the party associated to the conditional lien waiver document.

22. The method of claim 21, wherein the status changes if from an unpaid status to a paid status.
